(19) United States
(12) Patent Application Publication
(10) Pub. No.: US 2024/0340933 A1
(43) Pub. Date: Oct. 10, 2024

(54) SIDELINK RESOURCE SELECTION MODE 1 ENHANCEMENT WITH DIRECTIONAL BEAMS

(71) Applicant: Apple Inc., Cupertino, CA (US)

(72) Inventors: Huaning Niu, San Jose, CA (US); Chunxuan Ye, San Diego, CA (US); Dawei Zhang, Saratoga, CA (US); Wei Zeng, Saratoga, CA (US); Seyed Ali Akbar Fakoorian, San Diego, CA (US); Weidong Yang, San Diego, CA (US)

(21) Appl. No.: 18/611,845

(22) Filed: Mar. 21, 2024

Related U.S. Application Data
(60) Provisional application No. 63/494,085, filed on Apr. 4, 2023.

(51) Int. Cl. H04W 72/40; H04W 72/02; H04W 72/044

(52) U.S. Cl. CPC H04W 72/40; H04W 72/02; H04W 72/046

(57) ABSTRACT

Systems, methods, and processors are provided to support beamformed sidelink communication. In one example, a user equipment (UE) is configured for sidelink communication in a first unicast pair that includes the UE and a second UE. The UE includes a memory and one or more processors coupled to the memory. The one or more processors are configured to, when executing instructions stored in the memory, cause the UE to receive a message providing notification of sidelink communication between the UE and the second UE, and in response, perform sidelink communication of first sidelink data using a first transmit (TX) beam associated with the first unicast pair or a first receive (RX) beam associated with the first unicast pair.

### CROSS-REFERENCE TO RELATED APPLICATIONS

This application claims the benefit of priority from U.S. Provisional Patent Application 63/494,085 filed on Apr. 4, 2023 and entitled SIDELINK RESOURCE SELECTION MODE 1 ENHANCEMENT WITH DIRECTIONAL BEAMS, the specification of which is hereby incorporated by reference in its entirety.

### BACKGROUND

The present disclosure relates generally to wireless communication and more specifically to techniques for performing sidelink or device-to-device communication in a radio network.

### BRIEF DESCRIPTION OF THE DRAWINGS

Some examples of circuits, apparatuses and/or methods will be described in the following by way of example only. In this context, reference will be made to the accompanying figures.

FIG. 1A is a diagram of an example sidelink communication in which a receiving (RX) use equipment (UE) uses an omni-receiving antenna pattern.

FIG. 1B is a diagram of an example sidelink communication in which sidelink data is transmitted and received using beamforming antenna patterns.

FIG. 2 is a diagram of an example of a sidelink communication in which a notification message is provided UEs in a unicast pair scheduled for SL communication, in accordance with various aspects described.

FIG. 3 is a message flow diagram outlining messages exchanged during configuration of sidelink communication including a notification message indicating to a unicast pair that sidelink transmission is to occur, in accordance with various aspects described.

FIG. 4 is a message flow diagram outlining messages exchanged during configuration of sidelink communication wherein the notification message comprises an activation command, in accordance with various aspects described.

FIG. 5 is a message flow diagram outlining messages exchanged during configuration of sidelink communication wherein the notification message comprises downlink control information (DCI), in accordance with various aspects described.

FIG. 6 is a message flow diagram outlining messages exchanged during configuration of sidelink communication wherein the notification message comprises a configured grant message, in accordance with various aspects described.

FIG. 7 is a flow diagram outlining a method for performing directional sidelink communication, in accordance with various aspects described.

FIG. 8 is a flow diagram outlining a method for performing directional sidelink communication, in accordance with various aspects described.

FIG. 9 is a functional block diagram of a wireless communication network, in accordance with various aspects described.

FIG. 10 illustrates a simplified block diagram of a user equipment device, in accordance with various aspects described.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

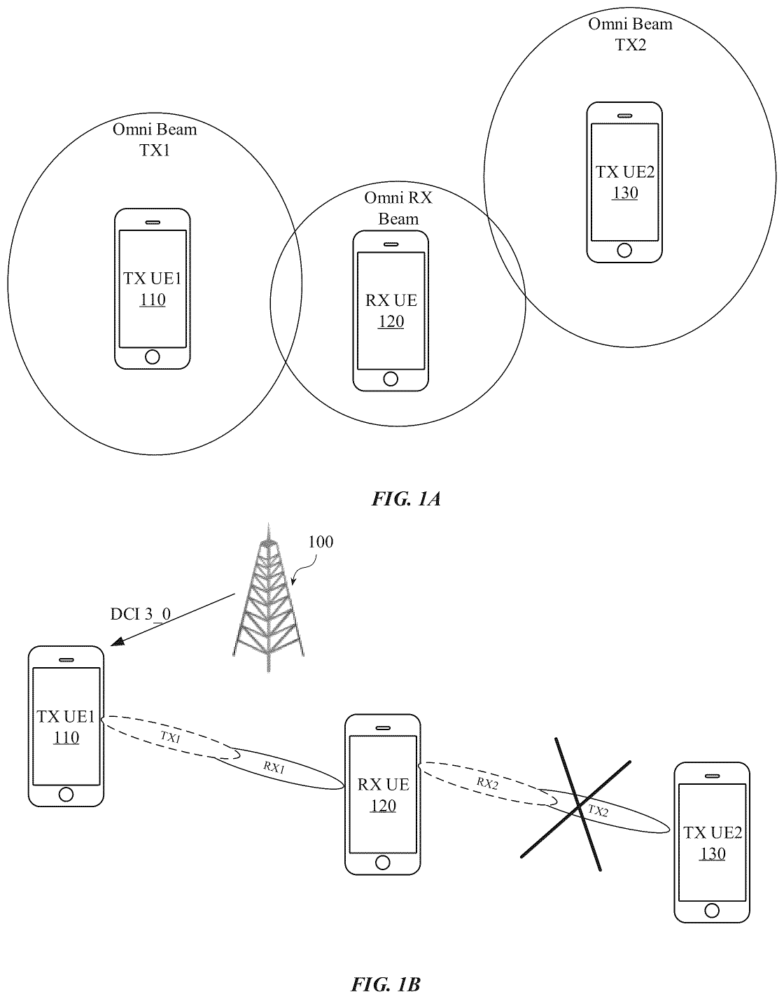

FIG. 1A illustrates an example of sidelink communication with omni-directional (hereinafter “omni”) transmission and receiving, in which a very wide antenna radiation pattern is used. Omni transmission and receiving may be performed in lower frequency (FR1) sidelink communication, or when beamforming is not performed. In FIG. 1A, UEs 110 and 120 are configured as a first unicast pair and UEs 120 and 130 are configured as a second unicast pair. In the illustrated sidelink communication UE 110 is transmitting a first transmission using omni-beam TX1 to UE 120 and, later, UE 130 is transmitting a second transmission to UE 120 using an omni beam TX2. Since the RX UE 120 uses an omni RX beam, the transmissions on TX1 and TX2 may both be received without the RX UE 220 making changes to antenna settings.

Sidelink communication that supports beamforming is an important aspect of new radio (NR) communication in high frequency bands (e.g., frequency range 2 (FR2)). In sidelink beamforming, pairs of UEs that are being configured as unicast pairs for sidelink communication may perform a link set up procedure to select TX and RX beams for use in directional sidelink communication within the unicast pair. When a unicast pair selects TX and RX beams, if a UE in the pair supports beam correspondence then the UE may use the same beam for transmitting to and receiving from the other UE in the unicast pair. If the UE does not support beam correspondence, then separate TX and RX beams are selected for use in sidelink communication with the other UE in the unicast pair. Thus, after link set up process, there may be a single TX/RX beam pair that is used for communication in the unicast pair, regardless of the direction of the transmission, or there may be two TX/RX beam pairs, with one pair for each direction of transmission.

When a UE is configured in multiple unicast pairs, the UE may select different beams for use in sidelink communication with different UEs. After a link is established, the UEs may perform measurements and beam re-selection, similar to what is done to maintain a Uu link, to maintain effective TX/RX beams for each unicast pair to which they belong.

FIG. 1B illustrates an example of sidelink communication in which directional (e.g., beamformed) transmitting and receiving are used. In FIG. 1B, UEs 110 and 120 are configured as a first unicast pair and UEs 120 and 130 are configured as a second unicast pair. During configuration as a unicast pair, UEs 110 and 120 select beams TX1 and RX1 for use in unicast communication between them. As disclosed above, a different TX/RX pair (not shown) may be selected for the unicast pair for transmission from UE 120 to UE 110. The second unicast pair, UEs 120 and 130, selects beams TX2 and RX2 for use in unicast communication between them. In the illustrated sidelink communication, UE 120 is tuned to receive on beam RX1 while UE 130 is transmitting a unicast transmission to UE 120 using beam TX2. It is likely that the transmission on beam TX2 will not be received by UE 120.

Disclosed herein are systems, methods, processors, and circuitries that support beamformed sidelink communication by providing notification message to UEs in a unicast pair when a sidelink transmission is or will be scheduled for the unicast pair. In this manner, the UEs in the unicast pair may tune their antennas to appropriate beams for transmitting or receiving the sidelink transmission.

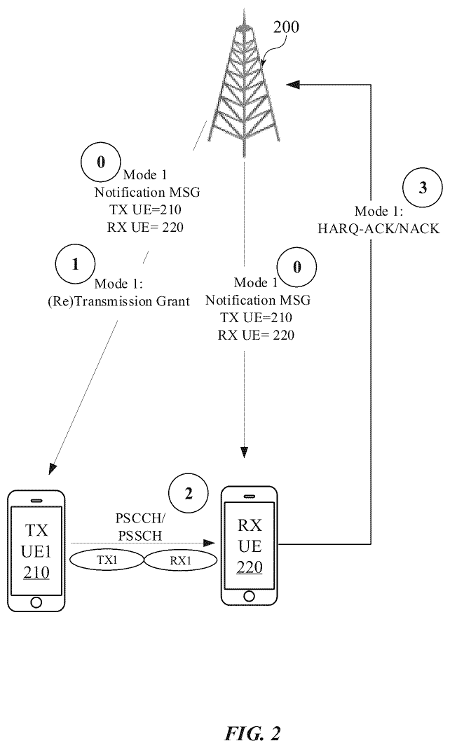

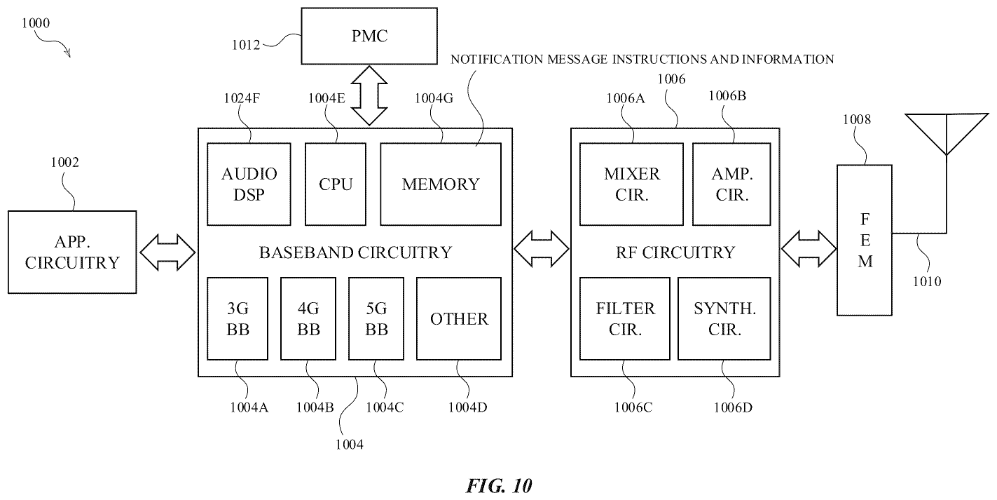

FIG. 2 is a block diagram of a wireless communication network in which UEs perform sidelink communication. Each UE in the network includes baseband circuitry that includes one or more processors configured to enable various types of sidelink communication. For the purposes of this description, when a “UE” or “device” is described as performing some function, it can be understood that it is the processor(s) in the baseband circuitry, in conjunction with stored instructions in a memory and/or transceivers(s) in some instances, that is performing the function. An example wireless communication device, including baseband circuitry, is illustrated in more detail in FIG. 10.

Sidelink communication may be performed according to one of two modes. In mode 2, the network preconfigures a pool of pre-allocated sidelink resources from which TX UEs may select transmission resources without requiring specific allocation from the network. In mode 2, HARQ-ACK/NACK signals are transmitted to the TX UE rather than the base station.

FIG. 2 illustrates mode 1 sidelink communication in which the network controls resource allocation and receives feedback for transport blocks (TBs) of a physical sidelink shared channel (PSSCH) transmission transmitted between UEs (e.g., by way of signals transmitted or received by a base station 100). In one example, at operation 1 resources for a sidelink transmission are signaled to the transmitting UE as a transmission grant.

The transmission grant may be, for example, downlink control information (DCI) format 3_0 as defined in 3GPP 38.212. The DCI format 3_0 includes, information about sidelink resources to be used for the sidelink transmission, a HARQ process number, a new data indicator, a sidelink control information (SCI) format to be used for scheduling with the RX UE, physical uplink control channel (PUCCH) resources to be used for HARQ feedback, codebook information, and so on. The message encoding the DCI is masked using a sidelink random network temporary identifier (SL-RNTI or a sidelink configured scheduling random network temporary identifier (SL-CS-RNTI) assigned to the TX UE. It is noted that the DCI format 3_0 is not transmitted to the RX UE of the unicast pair associated with the scheduled sidelink transmission. DCI format 3_0 is effective for scheduling sidelink communication when omni beams are used because the RX UE should receive the PSSCH regardless of a TX beam used by the TX UE.

At operation 2, the TX UE1 transmits physical sidelink control channel (PSCCH) carrying sidelink control information (SCI) stage 1, which communicates general sidelink channel information to all sidelink partners of the TX UE1. The TX UE1 210 transmits PSSCH carrying SCI stage 2 to the RX UE 220. The SCI stage 2 notifies the RX UE of the scheduled transmission corresponding to the transmission grant. At operation 3, a hybrid automatic repeat request (HARQ) acknowledgment/non-acknowledgement (ACK/NACK) signal received by the network from an RX UE. When the HARQ ACK/NACK indicates that a TB was not decoded by the RX UE, the network transmits a retransmission grant to the transmitting TX UE indicating resources to be used to retransmit the TB.

To support sidelink beamforming, the mode 1 scenario of FIG. 2 may be adapted. In FIG. 2, TX UE1 210 and RX UE 220 are configured as a unicast pair and sidelink TX/RX beams have been selected by the TX UE1 210 and RX UE 220 for sidelink communication between them. To alert the UEs in a unicast pair to tune their beams toward each other, when TX UE1 210 is to transmit to RX UE 220, at operation 0 the network (e.g., by way of serving base station 100) transmits a notification message to TX UE1 210 and RX UE 220 that identifies the TX UE and RX UE for the impending (e.g., scheduled or soon to be scheduled) transmission. At operation 1, the network transmits a transmission grant to TX UE1 210 for transmitting TBs to the RX UE 220. In some examples, the transmission grant itself may serve as the notification message as will be described in more detail below. At operation 2, the TX UE1 transmits PSCCH carrying sidelink control information (SCI) stage 1 and PSSCH carrying SCI stage 2 and the TBs to the RX UE 220. Since TX UE1 210 and RX UE 220 have tuned their beams to the selected beams for the unicast pair, the PSSCH should be successfully received by RX UE 220. At operation 3, HARQ-ACK feedback for the PSSCH is provided to the base station, if configured.

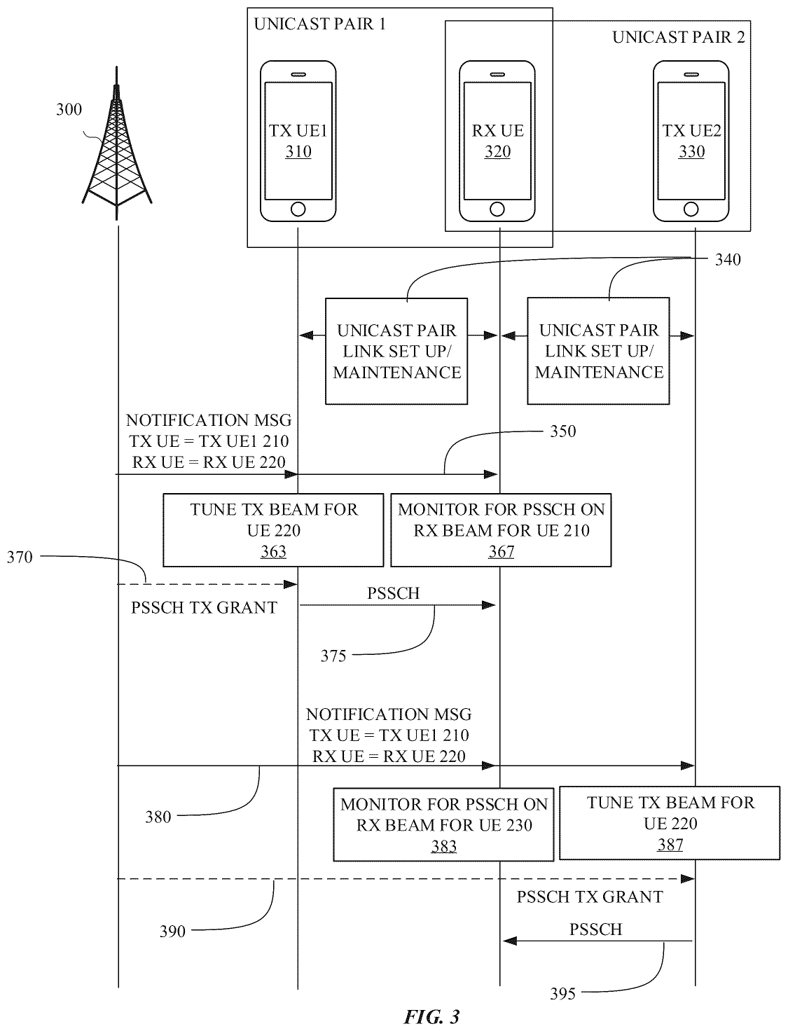

FIG. 3 is a message flow diagram outlining an example of beamformed sidelink communication using notification messages to alert UEs to tune their beams to a partner UE in a particular unicast pair in which a sidelink transmission is to occur. For the illustrated example, TX UE1 310 and RX UE 320 are configured as a first unicast pair. This means that the network, by way of messages transmitted from and received by base station 300, has configured a unicast pair that includes UE 310 and UE 320 and is enabled to schedule sidelink communication within the unicast pair. TX UE2 330 and RX UE 320 are configured as a second unicast pair. At 340, each unicast pair performs a link setup process. The link setup process includes the transmission and measurement of reference signals between the UEs in a unicast pair and a selection of TX and RX beams that are optimal for sidelink communication between the UEs in the pair.

Thus, after the link setup process 340 is complete, each UE is aware of unicast pairs in which it is configured and, for each unicast pair, the identity of its partner UE and at least a TX beam or an RX beam for use in transmitting and receiving sidelink data within the unicast pair. For link maintenance purposes, the link set up process performed at 340 is occasionally performed by each UE in the background, using periodic measurements and beam re-selection, so that at any given time, optimal beams for each unicast pair should be known.

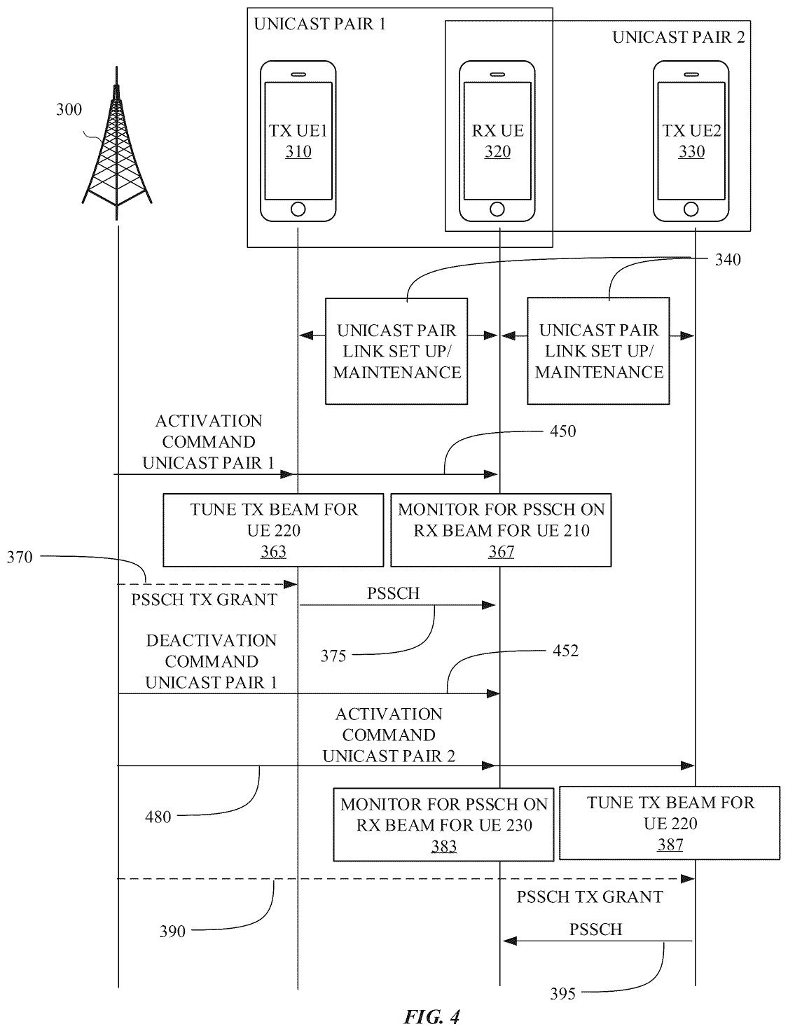

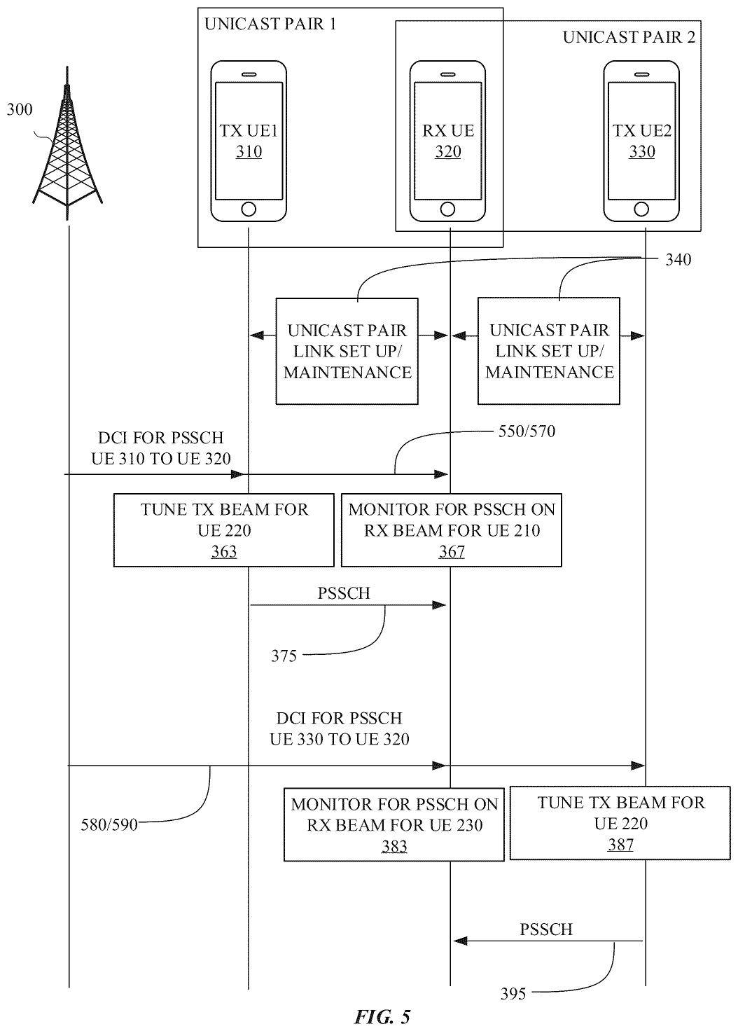

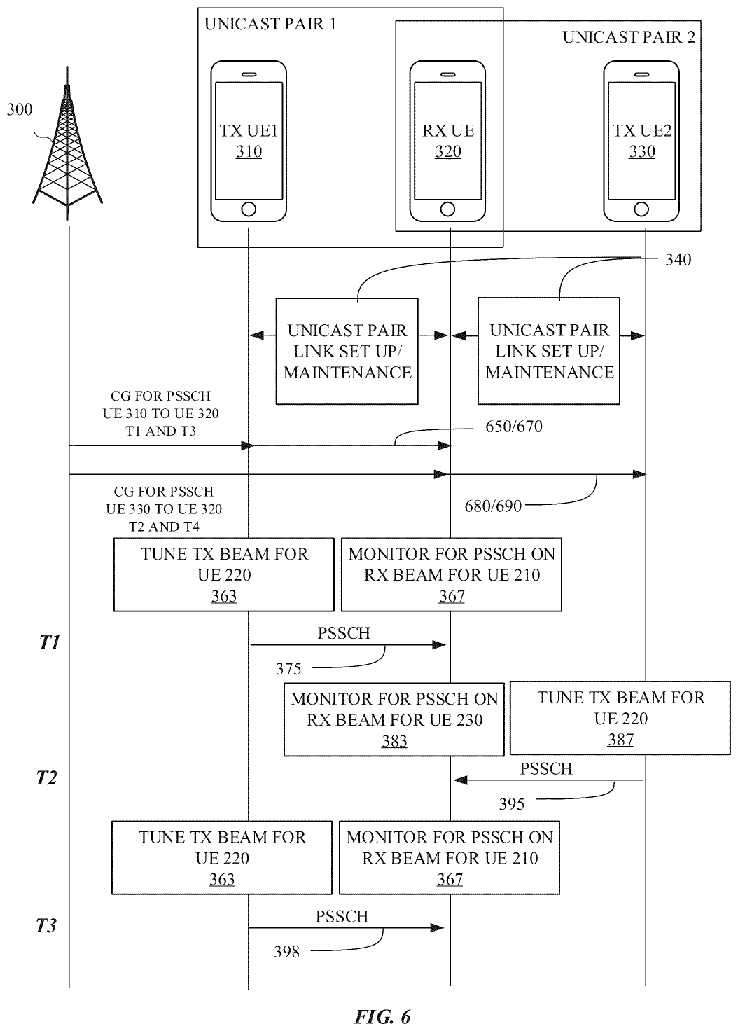

When the network is to schedule a sidelink data transmission for unicast pair 1, the base station 300 transmits a notification message 350 to the UEs in the unicast pair. The notification message indicates an identity of the TX UE and the RX UE for an impending sidelink data transmission. In the illustrated example, the notification message 350, is sent to and indicates TX UE1 310 as the TX UE and RX UE 320 as the RX UE, or unicast group 1. The notification message may be, for example, a activation command for a particular unicast pair (see FIG. 4), downlink control information (DCI) scheduling a sidelink transmission (see FIG. 5), or a configured grant scheduling semi-persistent sidelink transmissions (see FIG. 6).

In response to the notification message 350, at 363 the TX UE tunes to a selected TX beam and at 367 the RX UE tunes to a selected RX beam and monitors for PSSCH using that beam. The selected beams correspond to optimal beams determined at 340 for this unicast pair. In the illustrated example, UE 310 is notified that it is the TX UE and as such tunes its antenna(s) to the selected TX beam for transmitting to RX UE 320. Likewise, UE 320 is notified that it is the RX UE and as such tunes its antenna(s) to the selected RX beam for receiving from TX UE1 310.

The base station transmits a transmission grant 370 to TX UE1 310. The transmission grant indicates particular TBs to be transmitted and time and frequency resources to be used for the sidelink transmission. In some examples, the transmission grant may serve as both a transmission grant and the notification message, as will be described in more detail below. In response, the TX UE1 310 transmits the scheduled PSSCH 375 to the RX UE 320. Since the TX beam used to transmit the PSSCH and the RX beam used for receiving the PSSCH are optimal beams for the unicast pair 1, having been selected and maintained for the unicast pair 1, the PSSCH should be successfully received.

When the network is to schedule a sidelink data transmission for unicast pair 2, the base station 300 transmits a notification message 380 to the UEs in the unicast pair. The notification message indicates an identity of the TX UE and the RX UE for an impending sidelink data transmission. In the illustrated example, the notification message 380, is sent to and indicates TX UE1 330 as the TX UE and RX UE 320 as the RX UE, or unicast group 2. The notification message may be, for example, a activation command for a particular unicast pair (see FIG. 4), downlink control information (DCI) scheduling a sidelink transmission (see FIG. 5), or a configured grant scheduling semi-persistent sidelink transmissions (see FIG. 6).

In response to the notification message 380, at 383 the TX UE tunes to a selected TX beam and at 387 the RX UE tunes to a selected RX beam and monitors for PSSCH using that beam. The beams correspond to optimal beams determined at 340 for this unicast pair. In the illustrated example, UE 330 is notified that it is the TX UE and as such tunes its antenna(s) to the selected TX beam for transmitting to RX UE 320. Likewise, UE 320 is notified that it is the RX UE and as such tunes its antenna(s) to the selected RX beam for receiving from TX UE2 330.

The base station transmits a transmission grant 390 to TX UE1 310. The transmission grant indicates particular TBs to be transmitted and time and frequency resources to be used for the sidelink transmission. In some examples, the transmission grant may serve as both a transmission grant and the notification message, as will be described in more detail below. In response, the TX UE1 330 transmits the scheduled PSSCH 395 to the RX UE 320. Since the TX beam used to transmit the PSSCH and the RX beam used for receiving the PSSCH are optimal beams for the unicast pair 2, having been selected and maintained for the unicast pair 2, the PSSCH should be successfully received.

### Unicast Pair Activation Command as Notification Message

FIG. 4 is a message flow diagram outlining an example of beamformed sidelink communication in which the network coordinates sidelink communication of several unicast pairs by activating a single unicast pair at a time for sidelink transmission. In response to an activation command, the UEs in the activated unicast pair tune their beams to the selected TX beam and RX beam for the unicast pair. In this example, an activation command serves as the notification message.

As in FIG. 3, TX UE1 310 and RX UE 320 are configured as a first unicast pair and TX UE2 330 and RX UE 320 are configured as a second unicast pair. At 340, each unicast pair performs the link setup process so that each UE is aware of unicast pairs in which it is configured and, for each unicast pair, the identity of its partner UE and at least a TX beam or an RX beam for use in transmitting and receiving sidelink data within the unicast pair. For link maintenance purposes, the link set up process performed at 340 is occasionally performed by each UE in the background, using periodic measurements and beam re-selection, so that at any given time, optimal beams for each unicast pair should be known.

When the network is going to schedule a sidelink data transmission for unicast pair 1, prior to transmitting the transmission grant, the base station 300 transmits an activation command 450 to the UEs in unicast pair 1. The activation command may be radio resource control (RRC) signaling, in which case the unicast pair link may be considered as active by the network after an RRC processing delay. Alternatively, the activation command 450 may be a media access control element (MAC CE) that is transmitted to both UEs in the unicast pair (e.g., UE 310 and UE 320 in the illustrated example). When the MAC CE activation command is used, the unicast pair link may be considered as active by the network after about a 3 millisecond delay. In another option, the activation command may be a DCI format 3_0 that is received by (e.g., monitored for) both UEs in unicast pair 1.

The network may select which unicast pair to activate based on any number of factors, including network conditions, QoS considerations, scheduling requests, TX UE buffer status, and so on. To support unicast pair activation based on TX UE buffer status, a buffer status report (BSR) provided by the TX UEs to the network may be adapted to report buffer status on a per RX UE or unicast pair basis. This enables the network to select the appropriate unicast pair for activation.

In response to the activation command 450, the UEs in the unicast pair tune their antennas to the selected beams for the unicast pair. In the illustrated example, at 363 UE 310 tunes its antenna(s) to the selected TX beam for transmitting to RX UE 320. Likewise, at 367 UE 320 tunes its antenna(s) to the selected RX beam for receiving from TX UE1 310 and monitors for PSSCH using that beam.

The base station transmits the transmission grant 370 to the TX UE1 310. The transmission grant indicates particular TBs to be transmitted and time and frequency resources to be used for the sidelink transmission. In response, the TX UE1 310 transmits the scheduled PSSCH 375 to the RX UE 320. Since the TX beam used to transmit the PSSCH and the RX beam used for receiving the PSSCH have been selected and maintained for the unicast pair 1 by the process 340, the PSSCH should be successfully received.

When the network is to schedule a sidelink data transmission for unicast pair 2, the base station 300 transmits de-activation command 452 to the UEs of unicast pair 1 (TX UE1 310 and RX UE 320) to de-activate unicast pair 1. As described with reference to the activation command 450, the de-activation command may be RRC signaling, a MAC CE, or DCI, and so on. The base station 300 then transmits an activation command 480 to the UEs of unicast group 2. In response to the activation command 480, the UEs in the unicast pair tune their antennas to the selected beams for the unicast pair. In the illustrated example, at 383 UE 330 tunes its antenna(s) to the selected TX beam for transmitting to RX UE 320 and at 387 UE 320 tunes its antenna(s) to the selected RX beam for receiving from TX UE2 330 and monitors for PSSCH using that beam.

The base station transmits a transmission grant 390 to the TX UE1 310. The transmission grant indicates particular TBs to be transmitted and time and frequency resources to be used for the sidelink transmission. In response, the TX UE2 330 transmits the scheduled PSSCH 395 to the RX UE 320. Since the TX beam used for transmitting the PSSCH and the RX beam used for receiving the PSSCH have been selected and maintained for the unicast pair 2, the PSSCH 395 should be successfully received.

### DCI as Notification Message

FIG. 5 is a message flow diagram outlining an example of beamformed sidelink communication in which the network transmits DCI scheduling a sidelink transmission to both the TX UE and the RX UE in a unicast pair. In this example, the DCI serves as the notification message.

As in FIG. 3, TX UE1 310 and RX UE 320 are configured as a first unicast pair and TX UE2 330 and RX UE 320 are configured as a second unicast pair. At initial sidelink configuration by a higher layer, both UEs in the unicast pair may be assigned a common SL-RNTI or SL-CS-RNTI and may be configured to monitor certain PDCCH for DCI associated with the unicast pair. At 340, each unicast pair performs the link setup process so that each UE is aware of unicast pairs in which it is configured and, for each unicast pair, the identity of its partner UE and at least a TX beam or an RX beam for use in transmitting or receiving sidelink data within the unicast pair. For link maintenance purposes, the link set up process performed at 340 is occasionally performed by each UE in the background, using periodic measurements and beam re-selection, so that at any given time, optimal beams for each unicast pair should be known.

The base station 300 transmits DCI scheduling PSSCH to UE 310 and 320. In FIG. 5, the DCI is labeled as 550/570 because this message serves as the notification message (comparable to messages 350 of FIG. 3 and 450 of FIG. 4) and the transmission grant (comparable to messages 370 of FIG. 3 and 470 of FIG. 4). The DCI or a message carrying the DCI may be masked by the common SL-RNTI or SL-CS-RNTI. It is noted that if the TX UE and the RX UE have different Uu transmission configuration indicator (TCI) states, then the DCI 550/570 is transmitted on both TCI states by the base station.

In addition to scheduling resources for the sidelink transmission, the DCI may include a bit or flag or other feature that indicates which of the UEs in the unicast pair is the TX UE for the configured transmission. For example, the initial configuration of the unicast pair may include a configuration of one of the UEs as “0” and the other UE as “1” so that a bit within the DCI may be set to 0 or 1 to indicate which of the two UEs is the TX UE for the associated transmission grant.

In response to the DCI 550/570, the UEs in the unicast pair tune their antennas to the selected beams (e.g., resulting from process 340) for the unicast pair. In the illustrated example, at 363 UE 310 tunes its antenna(s) to the selected TX beam for transmitting to RX UE 320. Likewise, at 367 UE 320 tunes its antenna(s) to the selected RX beam for receiving from TX UE1 310 and monitors for PSSCH using that beam.

The TX UE1 310 transmits the scheduled PSSCH 375 to the RX UE 320. Since the TX beam and RX beam used for the PSSCH have been selected and maintained for the unicast pair 1, the PSSCH should be successfully received.

The base station 300 then transmits a DCI 580/590 scheduling PSSCH to the UEs of unicast group 2. In response to the DCI 580/590, the UEs in the unicast pair tune their antennas to the selected beams for the unicast pair. In the illustrated example, at 383 UE 330 tunes its antenna(s) to the selected TX beam for transmitting to RX UE 320 and at 387 UE 320 tunes its antenna(s) to the selected RX beam for receiving from TX UE2 330 and monitors for PSSCH using that beam.

The TX UE2 330 transmits the scheduled PSSCH 395 to the RX UE 320. Since the TX beam and RX beam used for the PSSCH have been selected and maintained for the unicast pair 2 using the process of 340, the PSSCH 395 should be successfully received.

In one example, the DCI is a group common DCI that is configured for the UEs of the unicast pair. Group common DCI is transmitted in a commonly configured search space for one or more UEs. The group common DCI may include a bit that indicates which UE of the unicast pair is to operate as the TX UE for an associated transmission grant.

It is noted that the use of DCI to alert UEs in a unicast pair to tune their beams toward one another is effective when both UEs are in coverage. If the RX UE is out of coverage, this approach may still sidelink communication may still be successful if the RX UE receives the PSSCH using an omni RX beam and HARQ feedback is not configured for the PSSCH.

### Configured Grant as Notification Message

FIG. 6 is a message flow diagram outlining an example of beamformed sidelink communication in which the network transmits a configured grant that schedules semi-persistent sidelink transmissions to both the TX UE and the RX UE in a unicast pair. In this example, the configured grant serves as a notification message that indicates particular times at which the unicast pairs tune their beams to the beams selected for the unicast pair.

As in FIG. 3, TX UE1 310 and RX UE 320 are configured as a first unicast pair and TX UE2 330 and RX UE 320 are configured as a second unicast pair. At 340, each unicast pair performs the link setup process so that each UE is aware of unicast pairs in which it is configured and, for each unicast pair, the identity of its partner UE and at least a TX beam or an RX beam for use in transmitting or receiving sidelink data within the unicast pair. For link maintenance purposes, the link set up process performed at 340 is occasionally performed by each UE in the background, using periodic measurements and beam re-selection, so that at any given time, optimal beams for each unicast pair should be known.

The base station 300 transmits an RRC type 1 configured grant (e.g., no activation DCI required) 650/670 scheduling PSSCH for unicast pair 1 at times T1 and T3 to UE 310 and UE 320. In one example, the time for the scheduled PSSCH is in terms of slots, so that T1 is slot 1 and T3 is slot 3. In FIG. 6, the configured grant is labeled as 650/670 because this message serves as the notification message (comparable to messages 350 of FIG. 3 and 450 of FIG. 4) and the transmission grant (comparable to messages 370 of FIG. 3 and 470 of FIG. 4). The configured grant 650/670 indicates a UE ID for the TX UE (e.g., UE 310) and a UE ID for the RX UE (e.g., UE 320). The base station 300 transmits an RRC configured grant 680/690 scheduling PSSCH for unicast pair 2 at times T2 and T4 to UE 330 and UE 320. T2 may be slot 2 and T4 may be slot 4. The configured grant 680/690 indicates a UE ID for the TX UE (e.g., UE 330) and a UE ID for the RX UE (e.g., UE 320). It is noted that if the TX UE and the RX UE in a unicast pair have different Uu transmission configuration indicator (TCI) states, then the configured grant 650/670 and/or 680/690 is transmitted on both TCI states by the base station.

In response to the configured grant 650/670, at a time prior to T1 (e.g., based on a time for tuning the UE's antennas) the UEs in unicast pair 1 tune their antennas to the selected beams for the unicast pair. In the illustrated example, at 363 UE 310 tunes its antenna(s) to the selected TX beam for transmitting to RX UE 320. Likewise, at 367 UE 320 tunes its antenna(s) to the selected RX beam for receiving from TX UE1 310 and monitors for PSSCH using that beam.

At T1 the TX UE1 310 transmits the scheduled PSSCH 375 to the RX UE 320. Since the TX beam for transmitting the PSSCH and the RX beam used for receiving the PSSCH have been selected and maintained for the unicast pair 1 in process 340, the PSSCH 375 should be successfully received.

In response to the configured grant 680/990 at a time prior to T2 (e.g., based on a time for tuning the UE's antennas) the UEs in unicast pair 2 tune their antennas to the selected beams for the unicast pair. In the illustrated example, at 383 UE 330 tunes its antenna(s) to the selected TX beam for transmitting to RX UE 320 and at 387 UE 320 tunes its antenna(s) to the selected RX beam for receiving from TX UE2 330 and monitors for PSSCH using that beam.

At T2, the TX UE2 330 transmits the scheduled PSSCH to the RX UE 320. Since the TX beam used for transmitting the PSSCH and RX beam used for receiving the PSSCH have been selected and maintained for the unicast pair 2 by process 340, the PSSCH 395 should be successfully received.

In response to the configured grant 650/670, at a time prior to T3 (e.g., based on a time for tuning the UE's antennas) the UEs in unicast pair 1 tune their antennas to the selected beams for the unicast pair. In the illustrated example, at 363 UE 310 tunes its antenna(s) to the selected TX beam for transmitting to RX UE 320. Likewise, at 367 UE 320 tunes its antenna(s) to the selected RX beam for receiving from TX UE1 310 and monitors for PSSCH using that beam.

At T3 the TX UE1 310 transmits the scheduled PSSCH 398 to the RX UE 320. Since the TX beam used to transmit the PSSCH and RX beam used for receiving the PSSCH have been selected and maintained for the unicast pair 1, the PSSCH should be successfully received. The actions at time T4 are not described for brevity sake. It can be seen that the RX UE 320 will switch its RX beam to the RX beam for unicast pair 1 to receive PSSCH at times T1 and T3 and to the RX beam for unicast pair 2 to receive PSSCH at time T2 and will successfully receive sidelink transmissions from both TX UE1 310 and TX UE2 330.

When a configured grant type 2 is used, which uses a separate DCI to activate and de-activate the associated transmissions, the DCI should be able to be decoded by both UEs in the unicast pair (e.g., transmitted to both UEs and masked based on a common SL-CS-RNTI).

It can be seen from the foregoing description that providing a sidelink transmission notification that alerts UEs in a unicast pair that a sidelink transmission is being scheduled allows for UEs to tune to beams selected for the unicast pair, thereby enabling beamformed sidelink communication.

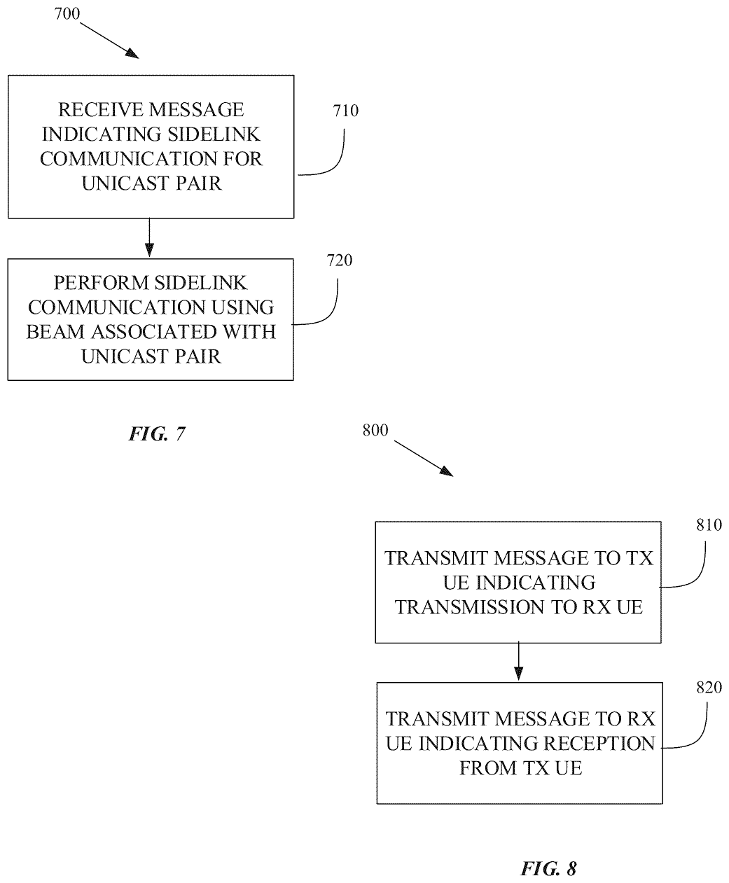

FIG. 7 is a flow diagram outlining a method 700 for performing sidelink beamforming. The method 700 may be performed by a TX UE or an RX UE in a first unicast pair as described with reference to FIGS. 3-6. The method includes, at 710, receiving a message indicating sidelink communication between the UE and a second UE in the first unicast pair. At 720, in response, sidelink communication of the first sidelink data is performed using a first transmit (TX) beam associated with the first unicast pair or a first receive (RX) beam associated with the first unicast pair.

In one example, disclosed with reference to FIG. 4, the message comprises a first activation command that activates a first unicast pair. In this example, the method may include receiving a second message deactivating the first unicast pair; receiving a second activation command that activates a second unicast pair including the UE and a third UE; and, in response, performing sidelink communication of second sidelink data with the third UE using a TX beam or an RX beam associated with the second unicast pair. An activation command for a second unicast pair is not expected while the first unicast pair is active. The activation command may be a radio resource control (RRC) message, a media access control (MAC) control element (CE), and/or downlink control information (DCI).

In another example, disclosed with reference to FIG. 5, the message comprises a downlink control information (DCI) message masked using a random network temporary identifier (RNTI) configured to the UE and second UE and the DCI includes a transmission grant for unicast sidelink transmission between the UE and the second UE. The DCI message may include a bit that indicates whether an associated TX grant is for the UE or the second UE. The message may comprise a group common DCI configured for the UE and the second UE.

In another example, disclosed with reference to FIG. 6, the message comprises a configured grant configuration message that includes a UE identifier (ID) for the UE and a UE ID for the second UE. The method may include receiving a second configured grant configuration message indicating second time domain resources for sidelink transmission and a UE ID for the UE and a third UE, wherein the UE and the third UE are a second unicast pair. In this example, in response, during first time domain resources associated with the first configured grant configuration message, sidelink communication of sidelink data with the second UE is performed using a TX beam or an RX beam associated with the first unicast pair, and during the second time domain resources, sidelink communication of sidelink data with the third UE is performed using a TX beam or an RX beam associated with the second unicast pair.

In one example, the method includes generating a buffer status report based on transmit sidelink data stored in a buffer on a per RX UE basis. This may assist a base station in determining a unicast pair for activation.

FIG. 8 is a flow diagram outlining a method 800 for performing sidelink beamforming. The method 800 may be performed by a base station configuring sidelink communication for a first unicast pair as described with reference to FIGS. 3-6. The method includes, at 810, transmitting a first message to a first UE of a unicast pair indicating that the first UE is to transmit sidelink data to a second UE of the unicast pair. At 820 a second message is transmitted to the second UE indicating that the second UE is to receive the sidelink data from the first UE. In some examples, the first message and second message comprise the same message which is decodable by two different UEs, two different messages with each message being decodable by one of the two UEs, the same message sent using two different TCI states, and so on.

In one example, disclosed with reference to FIG. 4, the first message and the second message comprise a first activation command that activates the first unicast pair. In this example, the method includes transmitting a deactivation command that deactivates the first unicast pair; transmitting a second activation command that activates a second unicast pair including a third UE and a fourth UE, wherein one of the third UE or the fourth UE is a member of the first unicast pair; and configuring a second sidelink transmission for the second unicast pair. The second activation command for the second unicast pair is not expected to be transmitted while the first unicast pair is active, so that only a single unicast pair that includes a common UE is active at any given time. The first activation command may include a radio resource control (RRC) message, a media access control (MAC) control element (CE), and/or downlink control information (DCI). The method may include determining a unicast pair to activate based on respective scheduling requests received from transmit UEs of respective unicast pairs or respective buffer status reports received from transmit UEs of respective unicast pairs, wherein the buffer status reports indicate buffer status on a per RX UE basis.

In one example, disclosed with reference to FIG. 5, the first message, the second message, or both the first message and the second message comprise DCI masked using a random network temporary identifier (RNTI) configured to the first UE and the second UE, wherein the DCI includes a transmission grant for the first UE for unicast sidelink transmission to the second UE. The DCI may include a bit that indicates whether an associated TX grant is for the first UE or the second UE of the first unicast pair. The first message, the second message, or both the first message and the second message may comprise a group common DCI configured for the first UE and the second UE.

In one example, disclosed with reference to FIG. 6, the first message, the second message, or both the first message and the second message comprise a configured grant configuration message that includes a UE identifier (ID) for the first UE and a UE ID for the second UE. In this example, the method may include transmitting an activation DCI for the configured grant that is decodable by the first UE and the second UE.

In one example, the method includes transmitting the first message to the first UE according to a transmission configuration indicator (TCI) state assigned to the first UE and transmitting the second message to the second UE according to a transmission configuration indicator (TCI) state assigned to the second UE.

Above are several flow diagrams outlining example methods and exchanges of messages. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term encode when used with reference to some entity or value of an entity is to be construed broadly as encompassing any manner or technique for generating a data sequence or signal that communicates the entity to another component.

As used herein, the term select when used with reference to some entity or value of an entity is to be construed broadly as encompassing any manner of determining the entity or value of the entity from amongst a plurality or range of possible choices. For example, the term select is to be construed to encompass accessing and reading memory (e.g., lookup table, register, device memory, remote memory, and so on) that stores the entities or values for the entity and returning one entity or entity value from amongst those stored. The term select is to be construed as applying one or more constraints or rules to an input set of parameters to determine an appropriate entity or entity value. The term select is to be construed as broadly encompassing any manner of choosing an entity based on one or more parameters or conditions.

As used herein, the term derive when used with reference to some entity or value of an entity is to be construed broadly. “Derive” should be construed to encompass accessing and reading memory (e.g., lookup table, register, device memory, remote memory, and so on) that stores some initial value or foundational values and performing processing and/or logical/mathematical operations on the value or values to generate the derived entity or value for the entity. The term derive should be construed to encompass computing or calculating the entity or value of the entity based on other quantities or entities. The term derive should be construed to encompass any manner of deducing or identifying an entity or value of the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

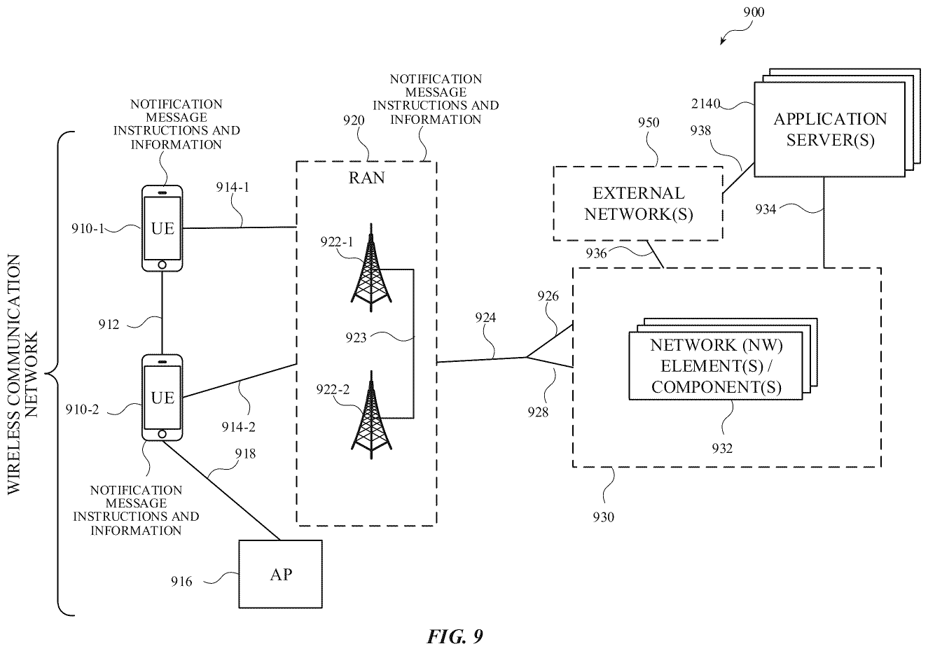

FIG. 9 is an example network 900 according to one or more implementations described herein. Example network 900 may include UEs 910-1, 910-2, etc. (referred to collectively as “UEs 910” and individually as “UE 910”), a radio access network (RAN) 920, a core network (CN) 930, application servers 940, and external networks 950.

The systems and devices of example network 900 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 900 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 910 may include smartphones (e.g., handheld touchscreen mobile computing devices connectable to one or more wireless communication networks). Additionally, or alternatively, UEs 910 may include other types of mobile or non-mobile computing devices capable of wireless communications, such as personal data assistants (PDAs), pagers, laptop computers, desktop computers, wireless handsets, watches etc. In some implementations, UEs 910 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 910 may use stored notification message instructions and information for performing one or more of the solutions disclosed with reference to FIGS. 3-8 to establish a beamformed connection with one or more other UEs 910 via one or more wireless channels 912, based on a notification message received from the RAN 920. UEs 910 may use one or more wireless channels 912 to communicate with one another. The connection may include an M2M connection, MTC connection, D2D connection, SL connection, etc. The connection may involve a PC5 interface. In some implementations, UEs 910 may be configured to discover one another, negotiate wireless resources between one another, and establish connections between one another, without intervention or communications involving RAN node 922 or another type of network node. In some implementations, discovery, authentication, resource negotiation, registration, etc., may involve communications with RAN node 922 or another type of network node.

As described herein, UE 910-1 may communicate with RAN node 922 to request SL resources. RAN node 922 may respond to the request by providing UE 910 with a dynamic grant (DG) or configured grant (CG) regarding SL resources. A DG may involve a grant based on a grant request from UE 910. A CG may involve a resource grant without a grant request and may be based on a type of service being provided (e.g., services that have strict timing or latency requirements). UE 910 may select SL resources based on the DG or CG; and communicate with another UE 910 based on the SL resources. The UE 910 may communicate with RAN node 922 using a licensed frequency band and communicate with the other UE 910 using an unlicensed frequency band. The UE 910 may tune its antennas to a beam selected for a unicast pair in response to a notification message received from the RAN node 922.

UEs 910 may communicate and establish a connection with (e.g., be communicatively coupled) with RAN 920, which may involve one or more wireless channels 914-1 and 914-2, each of which may comprise a physical communications interface/layer.

As described herein, UE 910 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 910 may also, or alternatively, connect to access point (AP) 916 via connection interface 918, which may include an air interface enabling UE 910 to communicatively couple with AP 916. AP 916 may comprise a wireless local area network (WLAN), WLAN node, WLAN termination point, etc. The connection 918 may comprise a local wireless connection, such as a connection consistent with any IEEE 702.11 protocol, and AP 916 may comprise a wireless fidelity (Wi-Fi®) router or other AP. While not explicitly depicted in FIG. 9, AP 916 may be connected to another network (e.g., the Internet) without connecting to RAN 920 or CN 930.

RAN 920 may include one or more RAN nodes 922-1 and 922-2 (referred to collectively as RAN nodes 922, and individually as RAN node 922) that enable channels 914-1 and 914-2 to be established between UEs 910 and RAN 920. RAN nodes 922 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, cNodeB, cNB, 4G base station, etc.), a next generation base station (e.g., a 5G base station, NR base station, next generation NBs (gNB), etc.). RAN nodes 922 may include a roadside unit (RSU), a transmission reception point (TRxP or TRP), and one or more other types of ground stations (e.g., terrestrial access points). In some scenarios, RAN node 922 may be a dedicated physical device, such as a macrocell base station, and/or a low power (LP) base station for providing femtocells, picocells or the like having smaller coverage areas, smaller user capacity, or higher bandwidth compared to macrocells. The RAN node 922 stores notification message instructions and information that cause the RAN node 922 to send a notification message via channels 914-1 and 914-2 to the UEs in a unicast pair to alert the UES that sidelink communication is to occur between them.

In some implementations, a downlink resource grid may be used for downlink transmissions from any of the RAN nodes 922 to UEs 910, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

The RAN nodes 922 may be configured to communicate with one another via interface 923. In implementations where the system is an LTE system, interface 923 may be an X2 interface. In NR systems, interface 923 may be an Xn interface. The X2 interface may be defined between two or more RAN nodes 922 (e.g., two or more eNBs/gNBs or a combination thereof) that connect to evolved packet core (EPC) or CN 930, or between two eNBs connecting to an EPC.

As shown, RAN 920 may be connected (e.g., communicatively coupled) to CN 930. CN 930 may comprise a plurality of network elements 932, which are configured to offer various data and telecommunications services to customers/subscribers (e.g., users of UEs 910) who are connected to the CN 930 via the RAN 920. In some implementations, CN 930 may include an evolved packet core (EPC), a 5G CN, and/or one or more additional or alternative types of CNs. The components of the CN 930 may be implemented in one physical node or separate physical nodes including components to read and execute instructions from a machine-readable or computer-readable medium (e.g., a non-transitory machine-readable storage medium

As shown, CN 930, application servers 940, and external networks 950 may be connected to one another via interfaces 934, 936, and 938, which may include IP network interfaces.

FIG. 10 is a diagram of an example of components of a network device according to one or more implementations described herein. In some implementations, the device 1000 can include application circuitry 1002, baseband circuitry 1004, RF circuitry 1006, front-end module (FEM) circuitry 1008, one or more antennas 1010, and power management circuitry (PMC) 1012 coupled together at least as shown. The components of the illustrated device 1000 can be included in a UE or a RAN node. In some implementations, the device 1000 can include fewer elements (e.g., a RAN node may not utilize application circuitry 1002, and instead include a processor/controller to process IP data received from a CN or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuitry 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 5G, 6G, etc.).

The baseband circuitry 1004 (e.g., one or more of baseband processors 1004A-D) can handle various radio control functions that enable communication with one or more radio networks via the RF circuitry 1006. In other implementations, some or all of the functionality of baseband processors 1004A-D can be included in modules stored in the memory 1004G and executed via a Central Processing Unit (CPU) 1004E. In some implementations, the baseband circuitry 1004 can include one or more audio digital signal processor(s) (DSP) 1004F.

In some implementations, memory 1004G may receive and/or store notification message instructions and information that cause the device, when acting as a RAN node, to send the notification message to the UEs in a unicast pair to alert the UES that sidelink communication is to occur between them. The notification message instructions and information cause the device, when acting as a UE, to tune its antenna to a beam associated with a unicast pair in response to receiving a notification message from a RAN node that alerts the UE that sidelink communication is to occur between a unicast pair to which the UE belongs.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path.

Examples herein can include subject matter such as a method, means for performing acts or blocks of the method, at least one machine-readable medium including executable instructions that, when performed by a machine or circuitry (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is a baseband processor of a user equipment (UE) configured for sidelink communication in a first unicast pair that includes a second UE, including a memory and a processor coupled to the memory. The processor configured to, when executing instructions stored in the memory, cause the UE to receive a message indicating sidelink communication between the UE and the second UE and, in response, perform sidelink communication of first sidelink data using a first transmit (TX) beam associated with the first unicast pair or a first receive (RX) beam associated with the first unicast pair.

Example 2 includes the subject matter of example 1, wherein the message includes a first activation command that activates a first unicast pair.

Example 3 includes the subject matter of example 2, wherein the processor is configured to receive a second message deactivating the first unicast pair; receive a second activation command that activates a second unicast pair including the UE and a third UE; and in response, perform sidelink communication of second sidelink data with the third UE using a TX beam or an RX beam associated with the second unicast pair.

Example 4 includes the subject matter of example 2, wherein the UE does not expect to receive an activation command for a second unicast pair while the first unicast pair is active.

Example 5 includes the subject matter of example 2, wherein the first activation command includes a radio resource control (RRC) message, a media access control (MAC) control element (CE), or downlink control information (DCI).

Example 6 includes the subject matter of example 1, wherein the message includes a downlink control information (DCI) message masked using a random network temporary identifier (RNTI) configured to the UE and second UE, wherein the DCI includes a transmission grant for unicast sidelink transmission between the UE and the second UE.

Example 7 includes the subject matter of example 6, wherein the DCI message includes a bit that indicates whether an associated TX grant is for the UE or the second UE.

Example 8 includes the subject matter of example 1, wherein the message includes a group common DCI configured for the UE and the second UE.

Example 9 includes the subject matter of example 1, wherein the message includes a configured grant configuration message that includes a UE ID for the UE and a UE ID for the second UE.

Example 10 includes the subject matter of example 19 wherein the configured grant configuration message indicates first time domain resources for sidelink transmission, further wherein the processor is configured to receive a second configured grant configuration message that includes a UE identifier (ID) for the UE and a third UE, and indicates second time domain resources for sidelink transmission, wherein the UE and the third UE include a second unicast pair; and in response, during the first time domain resources, perform sidelink communication of sidelink data with the second UE using a TX beam or an RX beam associated with the first unicast pair, and during the second time domain resources, perform sidelink communication of sidelink data with the third UE using a TX beam or an RX beam associated with the second unicast pair.

Example 11 includes the subject matter of example 1, wherein the processor is configured to generate a buffer status report based on transmit sidelink data stored in a buffer on a per RX UE basis.

Example 12 is a base station, including a memory and a processor coupled to the memory. The processor is configured to, when executing instructions stored in the memory, cause the base station to transmit a first message to a first UE of a first unicast pair indicating that the first UE is to transmit sidelink data to a second UE of the first unicast pair; and transmit a second message to the second UE indicating that the second UE is to receive the sidelink data from the first UE.

Example 13 includes the subject matter of example 12, wherein the first message and the second message include a first activation command that activates the first unicast pair.

Example 14 includes the subject matter of example 12, wherein the processor is configured to cause the base station to transmit a deactivation command that deactivates the first unicast pair; transmit a second activation command that activates a second unicast pair including a third UE and a fourth UE, wherein one of the third UE or the fourth UE is a member of the first unicast pair; and configure a second sidelink transmission for the second unicast pair.

Example 15 includes the subject matter of example 14, wherein the processor is configured to refrain from causing the base station to transmit the second activation command for the second unicast pair while the first unicast pair is active.

Example 16 includes the subject matter of example 13, wherein the first activation command includes a radio resource control (RRC) message, a media access control (MAC) control element (CE), or downlink control information (DCI).

Example 17 includes the subject matter of example 13, wherein the processor is configured to cause the base station to determine a unicast pair to activate based on respective scheduling requests received from transmit UEs of respective unicast pairs.

Example 18 includes the subject matter of example 13, wherein the processor is configured to cause the base station to determine a unicast pair to activate based on buffer status reports received from transmit UEs of respective unicast pairs, wherein the buffer status reports indicate buffer status on a per RX UE basis.

Example 19 includes the subject matter of example 12, wherein the first message, the second message, or both the first message and the second message include DCI masked using a random network temporary identifier (RNTI) configured to the first UE and the second UE, wherein the DCI includes a transmission grant for the first UE for unicast sidelink transmission to the second UE.

Example 20 includes the subject matter of example 19, wherein the DCI includes a bit that indicates whether an associated TX grant is for the first UE or the second UE of the first unicast pair.

Example 21 includes the subject matter of example 12, wherein the first message, the second message, or both the first message and the second message include a group common DCI configured for the first UE and the second UE.

Example 22 includes the subject matter of example 12, wherein the first message, the second message, or both the first message and the second message include a configured grant configuration message that includes a UE identifier (ID) for the first UE and a UE ID for the second UE.

Example 23 includes the subject matter of example 12, wherein the processor is configured to cause the base station to transmit the first message to the first UE according to a transmission configuration indicator (TCI) state assigned to the first UE; and transmit the second message to the second UE according to a transmission configuration indicator (TCI) state assigned to the second UE.

Example 24 is a user equipment (UE) that includes the baseband processor of any of claims 1-11.

Example 25 is an apparatus for a user equipment (UE) that includes the baseband processor of any of claims 1-11.

Example 26 is a method for a user equipment (UE) that includes steps corresponding to the operations performed by the UE as caused by the baseband processor of any of claims 1-11.

Example 27 is a computer readable medium storing processor-executable instructions, that when executed by a processor, cause the processor to cause a user equipment (UE) to perform the operations caused by the baseband processor of any of claims 1-11.

Example 28 is an apparatus for base station that includes the processor of any of claims 12-23.

Example 29 is a method for a base station that includes steps corresponding to the operations performed by the base station as caused by the processor of any of claims 12-23.

Example 30 is a computer readable medium storing processor-executable instructions, that when executed by a processor, cause the processor to cause a base station to perform the operations caused by the processor of any of claims 12-23.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases. In some embodiments, the methods illustrated above may be implemented in a computer readable medium using instructions stored in a memory. Many other embodiments and variations are possible within the scope of the claimed disclosure.

The term “couple” is used throughout the specification. The term may cover connections, communications, or signal paths that enable a functional relationship consistent with the description of the present disclosure. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A user equipment (UE) configured for sidelink communication in a first unicast pair that includes a second UE, comprising:
a memory; and
one or more processors coupled to the memory, the one or more processors configured to, when executing instructions stored in the memory, cause the UE to
receive a message providing notification of sidelink communication between the UE and the second UE; and
in response, perform sidelink communication of first sidelink data using a first transmit (TX) beam associated with the first unicast pair or a first receive (RX) beam associated with the first unicast pair.

2. The UE of claim 1, wherein the message comprises a first activation command that activates a first unicast pair.

3. The UE of claim 2, wherein the one or more processors are configured to cause the UE to
receive a second message deactivating the first unicast pair;
receive a second activation command that activates a second unicast pair including the UE and a third UE; and
in response, perform sidelink communication of second sidelink data with the third UE using a TX beam or an RX beam associated with the second unicast pair.

4. The UE of claim 2, wherein the UE does not expect to receive an activation command for a second unicast pair while the first unicast pair is active.

5. The UE of claim 2, wherein the first activation command comprises a radio resource control (RRC) message, a media access control (MAC) control element (CE), or downlink control information (DCI).

6. The UE of claim 1, wherein the message comprises a downlink control information (DCI) message masked using a random network temporary identifier (RNTI) configured to the UE and second UE, wherein the DCI includes a transmission grant for unicast sidelink transmission between the UE and the second UE.

7. The UE of claim 6, wherein the DCI message comprises a bit that indicates whether an associated TX grant is for the UE or the second UE.

8. The UE of claim 1, wherein the message comprises a group common DCI configured for the UE and the second UE.

9. The UE of claim 1, wherein the message comprises a configured grant configuration message that includes a UE ID for the UE and a UE ID for the second UE.

10. The UE of claim 9, wherein the configured grant configuration message indicates first time domain resources for sidelink transmission, further wherein the one or more processors are configured to cause the UE to
receive a second configured grant configuration message that includes a UE identifier (ID) for the UE and a third UE, and indicates second time domain resources for sidelink transmission, wherein the UE and the third UE comprise a second unicast pair; and
in response,
during the first time domain resources, perform sidelink communication of sidelink data with the second UE using a TX beam or an RX beam associated with the first unicast pair, and
during the second time domain resources, perform sidelink communication of sidelink data with the third UE using a TX beam or an RX beam associated with the second unicast pair.

11. The UE of claim 1, wherein the one or more processors are configured to generate a buffer status report based on transmit sidelink data stored in a buffer on a per RX UE basis.

12. A base station, comprising:
a memory; and
one or more processors coupled to the memory, the one or more processors configured to, when executing instructions stored in the memory, cause the base station to
transmit a first message to a first UE of a first unicast pair indicating that the first UE is to transmit sidelink data to a second UE of the first unicast pair; and
transmit a second message to the second UE indicating that the second UE is to receive the sidelink data from the first UE.

13. The base station of claim 12, wherein the first message and the second message comprise a first activation command that activates the first unicast pair.

14. The base station of claim 13, wherein the one or more processors are configured to cause the base station to
determine a unicast pair to activate based on respective scheduling requests received from transmit UEs of respective unicast pairs, or based on buffer status reports received from transmit UEs of respective unicast pairs, wherein the buffer status reports indicate buffer status on a per RX UE basis.

15. The base station of claim 12, wherein
the first message, the second message, or both the first message and the second message comprise a downlink control information (DCI) message masked using a random network temporary identifier (RNTI) configured to the first UE and the second UE, wherein the DCI includes a transmission grant for unicast sidelink transmission between the first UE and the second UE, and
the DCI comprises a bit that indicates whether an associated TX grant is for the first UE or the second UE of the first unicast pair.

16. The base station of claim 12, wherein the first message, the second message, or both the first message and the second message comprise a group common DCI configured for the first UE and the second UE.

17. The base station of claim 12, wherein the first message, the second message, or both the first message and the second message comprise a configured grant configuration message that includes a UE identifier (ID) for the first UE and a UE ID for the second UE.

18. A baseband processor, configured to perform operations comprising:
receiving a message providing notification of sidelink communication between user equipments (UEs) in a first unicast pair; and
in response, causing sidelink communication of first sidelink data using a first transmit (TX) beam associated with the first unicast pair or a first receive (RX) beam associated with the first unicast pair.

19. The baseband processor of claim 18, wherein the message comprises a first activation command that activates a first unicast pair.

20. The baseband processor of claim 18, wherein the message comprises
a downlink control information (DCI) message masked using a random network temporary identifier (RNTI) configured to a first UE and a second UE of the first unicast pair, wherein the DCI includes a transmission grant for unicast sidelink transmission between the first UE and the second UE, further wherein the DCI message comprises a bit that indicates whether an associated TX grant is for the first UE or the second UE;
a group common DCI configured for the first UE and the second UE; or
a configured grant configuration message that includes a UE ID for the first UE and a UE ID for the second UE.
